(19) United States
(12) Patent Application Publication
(10) Pub. No.: US 2013/0029165 A1
(43) Pub. Date: Jan. 31, 2013

(54) STABLE SILICATE SOLUTION FOR INHIBITING CORROSION

(71) Applicant: Marvin Johnson, Bartlesville, OK (US)

(72) Inventor: Marvin Johnson, Bartlesville, OK (US)

(21) Appl. No.: 13/471,335

(22) Filed: May 14, 2012

Related U.S. Application Data
(60) Provisional application No. 61/486,144, filed on May 13, 2011.

(51) Int. Cl. C09D 5/08; B32B 15/04; C08K 5/17

(52) U.S. Cl. 428/469; 524/249

(57) ABSTRACT

Novel anti-corrosion compositions and methods of using those solutions are provided. The solutions are preferably aqueous solutions comprising silicate and a silicate polymerization inhibitor. Upon contact with a metal surface to be protected, a silicate layer is formed on the surface, thus protecting that surface from corrosion. The solutions are useful in numerous systems, including oil and gas pipelines and wells and in amine treatment plants.

### CROSS REFERENCE TO RELATED APPLICATIONS

This application claims priority under 35 U.S.C. §199(e) from U.S. Provisional Application Ser. No. 61/486,144 filed May 13, 2011, which is hereby incorporated by reference in its entirety.

### FIELD OF THE INVENTION

Embodiments of the present invention are broadly concerned with preventing corrosion of metal surfaces with a silicate solution comprising a polymerization inhibitor.

### BACKGROUND

Metal will corrode through a redox reaction, during which the metal reacts with some substance in its environment. This is a common problem with many metals, but it is particularly significant for iron surfaces. Iron is known to rust in the presence of oxygen and water, and corrosion of iron is a problem in many industries because this iron/oxygen/water environment is quite common.

For example, corrosion presents a significant problem in the development of geoenergy sources, including oil and natural gas reserves, and geothermal and geopressured systems. When crude oil and natural gas are removed from a geologic formation they frequently contain CO₂ and H₂S (acid gases). Acid gas removal is commonly practiced in the oil refining, natural gas recovery, ammonia production, and wood pulp processing industries. Corrosion problems are aggravated by the presence of these acid gases and by the co-production of brine solutions. In recent years, corrosion problems have become more severe as production from deeper, high pressure and high temperature wells has become more prevalent, as these deeper formations typically have increased levels of acid gas fluids. Furthermore, as production falls off on older more mature oil and gas fields, more oxygen is present in the oil and gas streams.

The presence of oxygen and other impurities in a process gas stream is highly corrosive and adds considerable expense to the production and transportation of this product. Minimizing or eliminating the effects of oxygen is critical to preventing corrosion in pipelines and processing equipment. Equipment subject to the corrosive effects of oxygen plus the H₂S negatively affects the safety of those working with the equipment and ultimately impacts a company's profit margins. There is compelling evidence that when excess oxygen above the amount required to form the thiosulfate anion and iron are present, the highly corrosive polythionic acid anions are formed and corrosion is markedly enhanced.

Additives have been utilized to attempt to provide corrosion protection for metals used in oil and gas transportation and processing systems. Many current corrosion inhibitors do not consistently provide the desired degree of corrosion protection at varying temperatures and pressures. Another problem arises in the use of corrosion inhibitors in oil and gas systems and relates to how well the inhibitor is transported to the corroding surface within the system. If the inhibitor cannot be effectively and uniformly delivered through the system, there will be weaknesses in the level of protection achieved.

One method used for removing these acids and acid-forming impurities from hydrocarbon gases or fluids is by absorption in an amine regenerative solution absorbent unit. Regenerative amine units include columns with trays or other packing devices, which contact the forming compounds. The amine solution is most often regenerated by thermal stripping with steam, which removes the acids or acid-forming compounds such as H₂S, CO₂, mercaptans, and sulfides. This occurs when the gas stream enters the regeneration section of the unit containing a column with trays or other packing materials that introduce steam into the amine solution. The steam is formed in a reboiler and is forced through a reflux condenser and return system in which the water is conserved. Other heat exchange equipment is used to conserve energy and cool the amine prior to its return to the absorption section of the unit.

The presence of corrosive acids and acid-forming compounds in the treated streams corrodes the equipment (generally made of steel) containing the solution to be treated. Amine units present a variety of corrosion control problems often from unreacted CO₂ dissolved in the aqueous alkanolamine solution, resulting in acid species that are highly corrosive to metals. The iron in these steels is often hydrolyzed or oxidized to iron hydroxides or iron oxides. If H₂S is present in the absence of oxygen, H₂S reacts with the iron to form the metal sulfide, and the rate of corrosion is reduced. However, if the amount of H₂S present in the stream is small, it can react with oxygen to produce a polythionic acid and enhance corrosion. Corrosion in equipment that comes in contact with the treating solution increases with increased amine and acid gas concentration in the solution. The combination of amine and acid gas concentrations limits the overall capacity of the treating solution for removal of acid gas components from the gas or liquid stream to be treated. Corrosion, on any level, results because the stability of the hydrolyzed or oxidized steel that provides some passive resistance to corrosion is reduced when amine concentrations in treating solutions increase, and when the concentration of the acid component within the treating solution increases.

There is a need for new corrosion inhibiting compositions and methods of using those compositions to protect metal in the above environments as well as in other environments where metal corrosion is an issue.

### SUMMARY OF THE INVENTION

In one embodiment, the present invention is concerned with a method of treating a metallic surface. The method comprises contacting a composition with the metallic surface. The composition comprises a silicate and a silicate polymerization inhibitor dispersed or dissolved in a solvent system.

In another embodiment, the present invention provides a corrosion inhibitor comprising a silicate and a silicate polymerization inhibitor dispersed or dissolved in a solvent system. The silicate is present in the inhibitor at levels of less than about 500 ppm, preferably from about 25 ppm to about 400 ppm, and more preferably from about 45 ppm to about 300 ppm, or from about 50 ppm or about 75 ppm to about 100 ppm, about 150 ppm, or about 200 ppm. As used herein, about indicates ±20% variation of the value it describes.

Finally, in a further embodiment, the present invention is directed towards a treated metal comprising a metal surface having a coating formed on the surface. The coating comprises silicate interspersed with a silicate polymerization inhibitor.

### DETAILED DESCRIPTION OF THE PREFERRED EMBODIMENTS

Embodiments of the present invention overcome the problems of the prior art by providing a method of inhibiting, and preferably preventing, corrosion of metal (such as that exposed to gas and hydrocarbon treating solutions) by adding a silicate solution and specialized polymers to deionized water that can form an aqueous alkanolamine solution providing superior corrosion control.

In more detail, the anti-corrosion compositions used in the inventive methods comprise a silicate and a silicate polymerization inhibitor dispersed or dissolved in a solvent system. The silicate can be delivered to the composition by any typical silicate source, provided that source does not form a water-insoluble silicate. Preferred silicates are alkali metal silicates, with sodium silicate, potassium silicate, and mixtures thereof being particularly preferred.

Embodiments of the present invention also provide a method for delivering silicon throughout a system such as an amine treater, pipeline or storage tank to prevent or retard corrosion. This is done by using a polymerization inhibitor to retard the formation of a silicate protective layer such that the silicate protective layer can be dispersed throughout the system. Without the polymerization inhibitor rapid polymerization can occur near the point where the silicate solution is introduced and a deposit of the silicate near the entry is likely. This effect can be particularly pronounced at low pHs.

The silicate source is preferably provided in sufficient levels that silicate is present in the composition at levels of from about 5% to about 20% by weight, preferably from about 7% to about 15% by weight, and more preferably from about 10% to about 12% by weight, based upon the total weight of solids in the composition taken as about 100% by weight.

The silicate polymerization inhibitor can be any inhibitor that inhibits silicate polymerization to a sufficient degree that a silicate coating can be deposited on a surface. The silicate polymerization inhibitor can typically be a polymer, and is preferably a cationic polymer, although polyampholytes can also work provided they exhibit sufficient cationic character. The preferred cationicity (i.e., charge density) is at least about 5%, more preferably from about 10% to about 50%, and even more preferably from about 15% to about 20% or about 25%. Cationicity refers to the mole percent of the cationic monomer content in the silicate polymerization inhibitor, which can be measured via NMR spectroscopy. The typical average molecular weight of polymers used as a silicate polymerization inhibitor in some embodiments of the present invention is about 5,000,000 Daltons or more.

One preferred type of silicate polymerization inhibitor is a cationic or polyampholytic polyacrylamide. The polyacrylamide can be unsubstituted or substituted (e.g., polymethacrylamide). The polyacrylamide can be a homopolymer, or it can be a copolymer with other monomers such as those selected from the group consisting of ethylenic monomers (e.g., dimethylaminoethyl acrylate, dimethylaminoethyl methacrylate, dimethyldiallylammonium chloride, acrylamidopropyltrimethylammonium chloride, allylethyltriammonium chloride, methacrylamidopropyltrimethylammonium chloride), acrylic acid, methacrylic acid, acrylamidomethylpropylsulfonic acid, and mixtures thereof. In situations where the polymerization inhibitor is a copolymer of an acrylamide and one or more other monomers, it is preferred that the acrylamide monomer be present at a level of at least about 40 molar % or about 45 molar %, more preferably at least about 50 molar % or about 55 molar %, and even more preferably at least about 65 molar %, about 70 molar %, or about 75 molar %, based upon the total monomers in the polymer taken as about 100%. Particularly preferred polyacrylamides are sold under the name FLOPAM, by SNF, Inc., of Riceboro, Ga.

Further suitable silicate polymerization inhibitors include those selected from the group consisting of polydimethyldiallylammonium chloride, poly(2-methacyloyloxyethyl trimethyl ammonium methosulfate), polymethacrylamidopropyltrimethylammonium chloride, copolyacrylamide/methacrylamido propyltrimethylammonium chloride, polyethyleneimine, trimethyl ammonium chloride, didecyldimethyl ammonium chloride, polyethyleneoxide methyl ammonium chloride, trimethyl ammonium chloride, polydimethyldiallyl ammonium chloride/methylammonium chloride, polydimethyldiallyl ammonium chloride/trimethyl ammonium chloride , polyethylene imine/methylammonium chloride, polyethyleneimine/trimethylammonium chloride, polyethyleneimine/polydimethyldiallyl ammonium chloride, and mixtures of the foregoing.

Polyacrylic acid is a known silicate polymerization inhibitor. However, the adjacent carboxylate groups can also react with the iron oxide coating on the steel surface and form an iron complex that is water soluble and adds to corrosion. Thus, while polyacrylate can increase the retardation of the formation of a silicate protective layer, an increasing concentration of the acrylate can results in increased loss of iron from the iron or steel surfaces, because of the effect of the adjacent carboxylate groups.

Accordingly, in one embodiment, the silicate polymerization inhibitor does not include adjacent carboxylate groups such as those found in the sodium salts of polyacrylic acid. That is, the inhibitor may include monomers comprising carboxylate groups, but those monomers include intervening monomers that do not include carboxylate groups. Thus, less than about 50%, preferably less than about 45%, about 40%, or about 35%, and even more preferably less than about 30% or about 25% of the monomers include carboxylate groups.

The silicate polymerization inhibitor is preferably provided as a dilute solution that is easily transferred. That is, the solution can have a viscosity of less than about 1 poise. The quantity of silicate polymerization inhibitor is determined by the ease of handling and the ambient temperatures, but this can typically be present in the composition at a level of less than about 10% by weight, and preferably from about 2% to about 5% by weight, based upon the total weight of solids in the composition taken as about 100% by weight. Ideally, the weight ratio of silicate to silicate polymerization inhibitor is from about 2.5:1 to about 25:1, preferably from about 5:1 to about 15:1, and more preferably from about 9:1 to about 10:1 to about 11:1.

In one embodiment, the composition comprises or consists essentially of silicate (and any other components introduced as part of the silicate source) and the silicate polymerization inhibitor.

The anti-corrosion compositions are prepared by simply mixing the above ingredients in a solvent system under ambient conditions. The preferred solvent system comprises water, but can also include solvents selected from the group consisting of aqueous solutions of ammonia, alkoxy amines, diethanolamines, and mixtures thereof. The total solids content in the anticorrosion compositions is preferably from about 6% to about 33% by weight, preferably from about 8% to about 25% by weight, and more preferably from about 12% to about 20%, based upon the total weight of the composition taken as about 100% by weight. Thus, the solvent can be utilized at a level of from about 67% to about 94% by weight, preferably from about 75% to about 92% by weight, and more preferably from about 80% to about 88% by weight, based upon the total weight of the composition taken as about 100% by weight.

In use, the stable silicate composition is contacted with a metal surface that is to be protected from corrosion. The metal surface can be any type of metal (e.g., iron, iron alloys) and any such surface that may experience corrosion, including, but not limited to metal surfaces found in: oil and gas pipelines; oil and gas wells; and amine treatment equipment.

It will be appreciated that the quantity of the composition that is used in the particular system depends upon the conditions present in that particular system. Thus, as is common when using corrosion inhibitors, the end user would introduce an initial quantity of the stable silicate composition into the system. The system would then be monitored and periodically tested for the relevant metal levels to determine whether corrosion was still occurring. If the particular metal is present in the testing, a further quantity of the composition would be introduced into the system, followed by additional monitoring and analysis until that metal is not present. This would provide the injection levels for that particular system, and subsequent monitoring would reveal if further adjustments would be needed.

In a preferred embodiment, the composition is utilized at levels such that the silicate is maintained within the corrosion-causing gases and/or liquids at a concentration of from about 50 ppm to about 1,000 ppm silicate, more preferably from about 100 ppm to about 750 ppm silicate, and even more preferably from about 200 ppm or about 300 ppm to about 400 ppm or about 500 ppm silicate. This can be achieved by adding the anti-corrosion composition to the environment to be treated (e.g., absorption or amine treatment solution, oil or gas stream) when the concentration drops below a predetermined level. The silicate concentration can be determined by means known in the art (e.g., spectroscopy).

Advantageously, the solutions can form a silicate coating on the metal surfaces. This inhibits, and preferably prevents, corrosion by forming both a physical barrier to corrosion, as well as by interrupting the redox reaction that is associated with corrosion. The coating is preferably a substantially uniform coating, and can vary in thickness from a silicate monolayer to several layers of silicate in thickness. Soluble iron present in the system prior to addition of the corrosion inhibitor can be precipitated as an iron silicate, and the formation of polythionic acid anion can be avoided.

Having described the invention in detail, it will be apparent that modifications, variations, and equivalent embodiments are possible without departing the scope of the invention defined in the appended claims. Furthermore, it should be appreciated that all examples in the present disclosure are provided as non-limiting examples.

### Example

The following example sets forth certain preferred methods in accordance with some embodiments of the present invention. It is to be understood, however, that this example is provided by way of illustration and nothing herein should be taken as a limitation upon the overall scope of the invention.

Solutions A-C are prepared by mixing NaOH and commercial water glass in water under ambient conditions to form a 500-ppm of SiO in an equimolar NaOH/SiO₂ solution. For Solution A, a silicate polymerization inhibitor is also mixed into the solution. The inhibitor is a low-charge, cationic polyacrylamide (e.g., FLOPAM 4240 HS, available from SNF Inc., Riceboro, Ga.), resulting in Solution A having about 50 ppm polyacrylamide inhibitor and about 500 ppm SiO₂ Solution B is about 50% by weight diethanolamine, about 50% by weight water, about 50 ppm polyacrylamide inhibitor, and about 500 ppm SiO₂. Solution C is a control solution, having about 500 ppm SiO₂ but with no polymerization inhibitors added.

1-inch×1-inch×⅛-inch thick polished steel coupons (each having been pre-weighed, with the weight being recorded) are suspended in each solution. The solutions are shaken about every 12 hours for about 10 days. The coupons are then removed, washed with water, wiped with a soft cloth, rinsed in alcohol, and weighed.

With the polyacrylamide addition to the silicate solution, the desired protective silicate layer is formed, particularly at lower pH regions. This region corresponds to the region of entry of the gas to be treated in an absorber column, where the concentration of soluble acid gases is greatest, the temperature is the highest, and corrosion is the most aggressive. At the top of an absorber column, the pH is higher, the concentration of acid gases is minimal, and corrosion problems are less acute. Accordingly, to the extent that the efficacy of a polymerization inhibitor is pH-dependent, wherein inhibition decreases as pH increases, this efficacy gradient is not critical to the efficacy of the inventive method as a whole, because the concentration of acid gases likewise diminishes along a gradient from the bottom of an absorber column (with comparatively lower pH levels) to the top of such a column (where comparatively higher pH levels are found).

Inhibitors of silicate polymerization, including polyacrylamide inhibitors can promote formation of a significant silicate coating at relatively high pHs. In applications where low pHs, in the range of about 5 to about 9, are involved, such as in gathering lines and storage tanks, the mixture of the silicate solution and an inhibitor such as FLOPAM 424OHS polymerization inhibitor can function particularly well and give the desired corrosion protection throughout the system. Without the inhibitor, rapid polymerization can occur near the point where the silicate solution is introduced resulting in some cases in a disproportionate deposit of the silicate near the entry. This rapid polymerization effect can be particularly acute at low pHs, and it is at such low pHs that the value of a suitable polymerization is the greatest.

In this Example, even with Solution B, which is a mixture of about 50% water and diethanolamine, a comparatively small weight gain of the coupon is observed. This is due to the formation of silicate layers. The coupon after exposure closely resembles the original polished coupon. This is typical of the results expected for an amine-water system in the absence of acid gases that do not undergo the formation of the iron-redox reaction which involves the formation of the very corrosive polythionate anions by the iron-redox reaction from H₂S and excess oxygen. Solution B shows that the polymerization inhibitor in some embodiments of the present invention can be effective in an amine treater.

It is noted that silicate in solution reacts with iron oxide coating on the steel to form iron silicate, to prevent further corrosion. The use of the polymerization inhibitor in some embodiments of the present invention allows a more complete delivery of the silicate in solution throughout a system to allow the formation of the iron silicate coating throughout the system.

The various methods and techniques described above provide a number of ways to carry out the application. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some preferred embodiments specifically include one, another, or several features, while others specifically exclude one, another, or several features, while still others mitigate a particular feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof

In some embodiments, the numbers expressing quantities of ingredients, properties such as molecular weight, reaction conditions, and so forth, used to describe and claim certain embodiments of the application are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

In some embodiments, the terms “a” and “an” and “the” and similar references used in the context of describing a particular embodiment of the application (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application.

Preferred embodiments of this application are described herein. Variations on those preferred embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

What is claimed is:

1. A method of treating a metallic surface, said method comprising contacting a composition with said metallic surface, said composition comprising a silicate and a silicate polymerization inhibitor dispersed or dissolved in a solvent system.

2. The method of claim 1, wherein said contacting comprises introducing said composition into an environment subject to causing metal corrosion.

3. The method of claim 2, wherein said environment is selected from the group consisting of amine treatment solutions, oil streams, and gas streams.

4. The method of claim 2, wherein said environment comprises less than about 30% by weight water.

5. The method of claim 1, wherein said metallic surface comprises iron.

6. The method of claim 1, wherein said silicate polymerization inhibitor has a cationicity of at least about 5%.

7. The method of claim 6, wherein said silicate polymerization inhibitor comprises a polyacrylamide polymer or copolymer.

8. The method of claim 7, wherein said silicate polymerization inhibitor is a copolymer comprising acrylamide monomers and monomers of those selected from the group consisting of ethylenic monomers, acrylic acid, methacrylic acid , acrylamidomethylpropylsulfonic acid, and mixtures thereof

9. The method of claim 1, wherein said silicate polymerization inhibitor is selected from the group consisting of polydimethyldiallylammonium chloride, poly(2-methacyloyloxyethyl trimethyl ammonium methosulfate), polymethacrylamidopropyltrimethylammonium chloride, copolyacrylamide/methacrylamido propyltrimethylammonium chloride, polyethyleneimine, trimethyl ammonium chloride, didecyldimethyl ammonium chloride, polyethyleneoxide methyl ammonium chloride, trimethyl ammonium chloride, polydimethyldiallyl ammonium chloride/methylammonium chloride, polydimethyldiallyl ammonium chloride/trimethyl ammonium chloride, polyethyleneimine/methylammonium chloride, polyethyleneimine/trimethylammonium chloride, polyethyleneimine/polydi-methyldiallyl ammonium chloride, and mixtures of the foregoing.

10. The method of claim 1, wherein said composition comprises a silicate to silicate polymerization inhibitor weight ratio of from about 2.5:1 to about 25:1.

11. A corrosion inhibitor comprising a silicate and a silicate polymerization inhibitor dispersed or dissolved in a solvent system, said silicate being present in the inhibitor at levels of less than about 500 ppm.

12. The inhibitor of claim 11, wherein said silicate polymerization inhibitor has a cationicity of at least about 5%.

13. The inhibitor of claim 12, wherein said silicate polymerization inhibitor comprises a polyacrylamide polymer or copolymer.

14. The inhibitor of claim 13, wherein said silicate polymerization inhibitor is a copolymer comprising acrylamide monomers and monomers of those selected from the group consisting of ethylenic monomers , acrylic acid , methacrylic acid, acrylamidomethylpropylsulfonic acid, and mixtures thereof.

15. The inhibitor of claim 11, wherein said silicate polymerization inhibitor is selected from the group consisting of polydimethyldiallylammonium chloride, poly(2-methacyloyloxyethyl trimethyl ammonium methosulfate), polymethacrylamidopropyltrimethylammonium chloride, copolyacrylamide/methacrylamido propyltrimethylammonium chloride, polyethyleneimine, trimethyl ammonium chloride, didecyldimethyl ammonium chloride, polyethyleneoxide methyl ammonium chloride, trimethyl ammonium chloride, polydimethyldiallyl ammonium chloride/methylammonium chloride, polydimethyldiallyl ammonium chloride/trimethyl ammonium chloride, polyethyleneimine/methylammonium chloride, polyethyleneimine/trimethylammonium chloride, polyethyleneimine/polydi-methyldiallyl ammonium chloride, and mixtures of the foregoing.

16. The inhibitor of claim 11, wherein said composition comprises a silicate to silicate polymerization inhibitor weight ratio of from about 2.5:1 to about 25:1.

17. A treated metal comprising a metal surface having a coating formed thereon, said coating comprising silicate interspersed with a silicate polymerization inhibitor.

18. The metal of claim 17, wherein said metal is in contact with an environment selected from the group consisting of amine treatment solutions, oil streams, and gas streams.

19. The metal of claim 18, wherein said environment comprises less than about 30% by weight water.

20. The metal of claim 17, wherein said metallic surface comprises iron.

21. The metal of claim 17, wherein said silicate polymerization inhibitor has a cationicity of at least about 5%.

22. The metal of claim 21, wherein said silicate polymerization inhibitor comprises a polyacrylamide polymer or copolymer.

23. The metal of claim 22, wherein said silicate polymerization inhibitor is a copolymer comprising acrylamide monomers and monomers of those selected from the group consisting of ethylenic monomers, acrylic acid, methacrylic acid, acrylamidomethylpropylsulfonic acid, and mixtures thereof.

24. The metal of claim 17, wherein said silicate polymerization inhibitor is selected from the group consisting of polydimethyldiallylammonium chloride, poly(2-methacyloyloxyethyl trimethyl ammonium methosulfate), polymethacrylamidopropyltrimethylammonium chloride, copolyacrylamide/methacrylamido propyltrimethylammonium chloride, polyethyleneimine, trimethyl ammonium chloride, didecyldimethyl ammonium chloride, polyethyleneoxide methyl ammonium chloride, trimethyl ammonium chloride, polydimethyldiallyl ammonium chloride/methylammonium chloride, polydimethyldiallyl ammonium chloride/trimethyl ammonium chloride, polyethyleneimine/methylammonium chloride, polyethyleneimine/trimethylammonium chloride, polyethyleneimine/polydi-methyldiallyl ammonium chloride, and mixtures of the foregoing.
